(19) United States
(12) Patent Application Publication
(10) Pub. No.: US 2026/0170679 A1
(43) Pub. Date: Jun. 18, 2026

(54) ACCIDENT PREVENTION SYSTEM FOR EARLY DETECTION OF A POTENTIAL ACCIDENT OF A TARGET USER

(71) Applicant: Centre for Intelligent Multidimensional Data Analysis Limited, Pak Shek Kok (HK)

(72) Inventors: Hong Yan, Pak Shek Kok (HK); Man Wah Gloria Lee, Pak Shek Kok (HK); Wah Cheung Wong, Pak Shek Kok (HK); Zhen Zhu, Pak Shek Kok (HK); Haiquan Wu, Pak Shek Kok (HK); Kin Hei Man, Pak Shek Kok (HK)

(21) Appl. No.: 18/982,177

(22) Filed: Dec. 16, 2024

(51) Int. Cl. G06T 7/73; G06F 3/01; G06V 20/52; G08B 31/00

(52) U.S. Cl. CPC G06T 7/73; G06F 3/011; G06V 20/52; G08B 31/00

(57) ABSTRACT

An accident prevention system for early detection of a potential accident, such as a fall, of a target user, including: an image capturing module arranged to capture one or more images associated with the movement of the target user within a real-world environment; a pose estimation module arranged to estimate the pose of the target user based on the captured image associated with the movement of the target user within the real-world environment; and an accident prediction module arranged to predict the potential hazardous event of the target user within the real-world environment based on the estimated pose.

### TECHNICAL FIELD

The invention relates to an accident prevention system for early detection of a potential accident, and particularly, although not exclusively, to an accident prevention system for early detection of a potential accident of an elderly user.

### BACKGROUND

Recent survey results indicate that the risk of falling significantly increases with age. Among individuals aged 65 to 74, 61.8% reported falls, while an even higher proportion of 88.6% was observed in those aged 75 and above.

The consequences of falls are severe, leading to injuries, fractures, financial burdens, and a decreased ability to self-care. This underscores the critical need for early identification of fall risk factors and the implementation of effective fall prevention strategies for the elders.

### SUMMARY OF THE INVENTION

In accordance with a first aspect of the present invention, there is provided an accident prevention system for early detection of a potential accident of a target user, comprising:
an image capturing module arranged to capture one or more images associated with the movement of the target user within a real-world environment;
a pose estimation module arranged to estimate the pose of the target user based on the captured image associated with the movement of the target user within the real-world environment; and
an accident prediction module arranged to predict the potential hazardous event of the target user within the real-world environment based on the estimated pose.

In accordance with the first aspect, the accident prediction module further comprises a machine learning network model configured to determine one or more parameters associated with the potential hazardous event.

In accordance with the first aspect, the identity of the target user is filtered through the pose estimation whereby the privacy of the target user is protected.

In accordance with the first aspect, the pose estimation module is configured to generate a graphical representation associated with the estimated pose of the target user from the captured image.

In accordance with the first aspect, the generated graphical representation associated with the estimated pose of the target user is independent of the identity of the target user.

In accordance with the first aspect, the pose estimation module is configured to generate a skeleton associated with the estimated pose of the target user.

In accordance with the first aspect, the accident prediction module is configured to predict the occurrence of the potential hazardous event prior to the actual occurrence of the predicted hazardous event.

In accordance with the first aspect, the accident prediction module is configured to compare the estimated pose against one or more predetermined pose references.

In accordance with the first aspect, the accident prediction module is arranged to determine the elevated level of the target user relative to the ground level in the real-world environment.

In accordance with the first aspect, the accident prediction module is configured to determine the presence of a real-world object within the real-world environment associated with the captured image.

In accordance with the first aspect, the accident prediction module is configured to determine the interaction between the target user and the real-world object within the real-world environment.

In accordance with the first aspect, the accident prediction module is configured to determine the lifting of a real-world object by the target user.

In accordance with the first aspect, the accident prediction module is configured to determine the velocity of the target user.

In accordance with the first aspect, the accident prediction module is configured to determine the obstacle obstructing the movement of the target user within the real-world environment.

In accordance with the first aspect, the accident prediction module is configured to determine the occurrence of an actual hazardous event in real-time.

In accordance with the first aspect, the accident prediction module is configured to record a high-risk activity of the target user contributing to the predicted hazardous event.

In accordance with the first aspect, the accident prediction module is configured to record the statistics associated with the high-risk activity of the target user.

In accordance with the first aspect, the accident prediction module is configured to alert a remote user the occurrence of a potential hazardous event.

In accordance with the first aspect, further comprising a display module configured to graphically display to the remote user in real-time a skeleton associated with the estimated pose of the target user.

In accordance with the first aspect, the display module is further configured to display the information associated with the predicted hazardous event.

### BRIEF DESCRIPTION OF THE DRAWINGS

Embodiments of the present invention will now be described, by way of example, with reference to the accompanying drawings in which:

FIG. 1 is a schematic diagram showing an accident prevention system in accordance with an embodiment of the present invention.

FIG. 2 depicts an accident prevention system in accordance with another embodiment of the present invention.

FIG. 3 is a schematic diagram showing the workflow of the accident prevention system in accordance with an embodiment of the present invention.

FIG. 4 illustrates a splash screen presented on the display of the accident prevention system shown in FIG. 1.

FIG. 5 illustrates another splash screen presented on the display of the accident prevention system shown in FIG. 1.

FIG. 6 illustrates yet another splash screen presented on the display of the accident prevention system shown in FIG. 1.

FIG. 7 depicts a partial splash screen shown in FIG. 5 with the accompanying info.

FIG. 8 depicts a partial splash screen shown in FIG. 6 with the accompanying info.

### DETAILED DESCRIPTION OF THE PREFERRED EMBODIMENTS

Without wishing to be bound by theory, the inventors have discovered that it would be feasible to address the risk of falling proactively so as to mitigate the adverse effects and improve the overall quality of life for elders. However, the current researchers face various challenges. For instance, it would be difficult to identify external environmental and behavioral fall risks. The existing system in the market merely focus on fall detection rather than preventive measures. The recording of the activity for preventive measure may also raise the privacy concerns associated with camera-based video surveillance.

In accordance with one example embodiment of the present invention, there is provided an Artificial Intelligence of Things (AIoT) enabled falling prevention system. The camera-based AI system may early detect the risk of falling at home and other potential dangers in the home environment. The system may send alert notifications to family members, caregivers and professionals. Meanwhile, the sensitive information associated with target user can be hidden so that the privacy of the target user is protected.

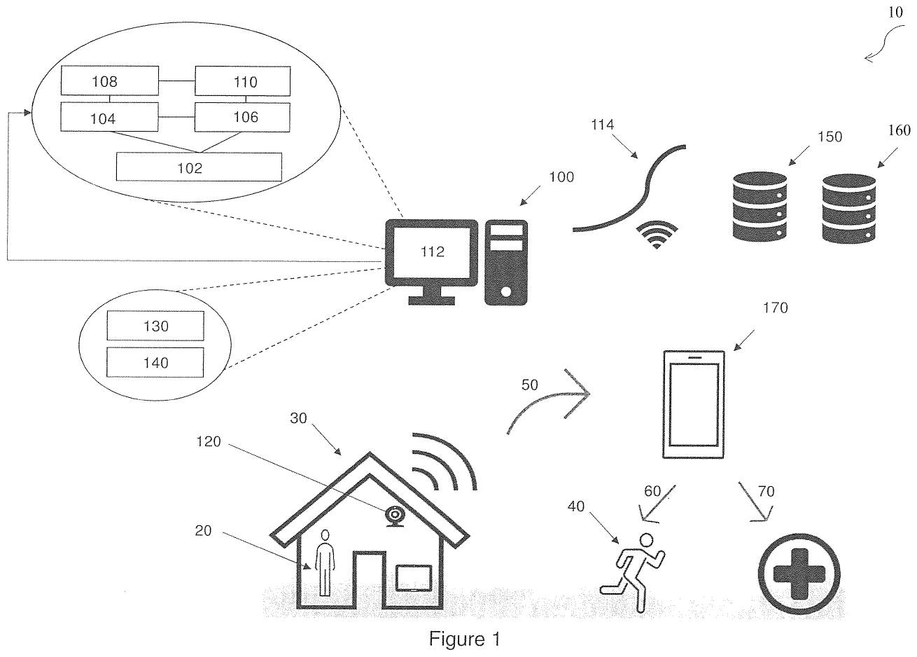

With reference to FIG. 1, there is shown an embodiment of an accident prevention system 10 for early detection of a potential accident of a target user 20, comprising: an image capturing module 120 arranged to capture one or more images associated with the movement of the target user 20 within a real-world environment 30; a pose estimation module 130 arranged to estimate the pose of the target user 20 based on the captured image associated with the movement of the target user 20 within the real-world environment 30; and an accident prediction module 140 arranged to predict the potential hazardous event of the target user 20 within the real-world environment 30 based on the estimated pose.

For the purposes of this document, the term “target user” includes any type of users, such as, but not limited to, human and non-human users such as elders, kids, minors, infants, underprivileged which may require some intensive care by a caretaker. The term “hazardous event” includes different types of events such as standing on a chair, climbing on a ladder, lifting up heavy items, falling on the floor etc.

As shown in FIG. 1 there is a shown a schematic diagram of an accident prevention system 10 and a target user 20 preferably an elderly user interacting with the system 10. The overall architecture of the accident prevention system 10 in accordance with one example embodiment of the present invention is implemented by a computer apparatus 100 equipped with a plurality of hardware and software.

In one system usage scenario in accordance with the present invention, the system 10 may be installed in an elderly home 30 for early detection of the potential accident, such as, but not limited to, a fall or other hazards, of an elderly user 20 and the remote caretaking by a caretaker 40. In use, the image capturing module 120 may capture the daily activity of the elderly user 20 and the pose estimation module 130 may estimate the pose of the elderly user 20 based on the captured images. Upon the accident prediction module 140 has conducted some risk analysis, the system 100 may send an alert or a message 50 e.g., a notification and/or a recommendation to the smartphone 170 of the caretaker 40. The caretaker 40 may then verify the status of the elderly user 20 through the smartphone 170 or giving a call to the elderly user 20 directly. In the event that the elderly user 20 faces a potential hazardous event, the caretaker 40 may provide immediately assistance 60 to rescue the elderly user 20 or alternatively call the emergency hotline 70 for external assistance.

The accident prevention system 10 comprises the computing apparatus 100. Referring to FIG. 1, the computing apparatus 100 includes suitable components necessary to receive, store and execute appropriate computer instructions. The components may include a processing unit 102, including Central Processing United (CPUs), Math Co-Processing Unit (Math Processor), Graphic Processing Unit (GPUs) or Tensor Processing Unit (TPUs) for tensor or multi-dimensional array calculations or manipulation operations, read-only memory (ROM) 104, random access memory (RAM) 106, and input/output devices such as disk drives 108, a user interface such as a keyboard, touchscreen. The computing apparatus 100 may comprise other input devices 110 such as an Ethernet port, a USB port, etc. The computing apparatus 100 may also include a display 112 such as a liquid crystal display, a light emitting display or any other suitable display and communications links (i.e., a communication interface) 114.

The computing apparatus 100 may include instructions that may be included in ROM 104, RAM 106, or disk drives 108 and may be executed by the processing unit 102. There may be provided with one or more communication interfaces (i.e., one or more communication links) 114 which may variously connect to one or more computing devices such as a server, personal computers, terminals, embedded computing systems, wireless or handheld computing devices, Internet of Things (IoT) devices, smart devices, edge computing devices. At least one of a plurality of communications link may be connected to an external computing network through a telephone line or other type of communications link. The communication interface 114 is configured to allow communication of data via any suitable communication network using any suitable protocol such as for example Wi-Fi, Bluetooth, 4G, 5G or any other suitable protocol.

The computing apparatus 100 may include storage devices such as a disk drive 108 which may encompass solid state drives, hard disk drives, optical drives, magnetic tape drives or remote or cloud-based storage devices. The computing apparatus 100 may use a single disk drive or multiple disk drives, or a remote storage service. The computing apparatus 100 may also have a suitable operating system which resides on the disk drive or in the ROM of the computing apparatus 100.

The computing apparatus 100 further comprises an image capturing module 120 which includes one or more cameras to capture a plurality of images or a video stream within a predetermined time period. As shown in FIG. 1 the computing apparatus 100 comprises a camera 120. The camera 120 may be a webcam or other suitable camera. The camera 120 may be a separate unit that is mounted on a wall or ceiling or on a tripod. The camera 120 may also be an integrated unit that is coupled to the one of the input devices 110. The camera 120 is arranged in electronic communication with the processor 102. The processor 102 is configured to receive recorded images or a recorded video from the camera 120 and process the images or video from the camera 120 in real-time.

Importantly, the camera 120 may capture the images or video of an elderly user 20, and the captured image may be processed by the processor 102 so as to identify the activities of the elderly user 20 without revealing the identity of the elderly user 20. The processor 102 may also remove the elderly user 20 from the processed image and present the limbs of the elderly user 20 in the form of a graphical representation such as a stickman.

The computing apparatus 100 may also comprise a pose estimation module 130 to estimate the pose of the elderly user 20 based on the image capturing the movement of the elderly user 20. In particular, the pose estimation module 130 may first identify the relevant region of interest (ROI) in the captured image concerning the elderly user 20 and compare the differences between a plurality of consecutive captured images to predict the activity of the elderly user 20.

For instance, the pose estimation module 130 may detect the region of interest (ROI) of the elderly user 20 in the consecutive captures images and compare the height of the target user 20 with respect to the ground level. If it detects a positive change of height, this represents the elderly user 20 may be performing a climbing action. Alternatively, the pose estimation module 130 may also detect the region of interest (ROI) of the elderly user 20 in the consecutive captures images and determine the horizontal displacement of the target user 20. If it detects a significant change of displacement, this represents the elderly user 20 may be running within the premise.

The computing apparatus 100 may also comprise an accident prediction module 140 to predict the potential hazardous event of the elderly user 20 based on the comparison between estimated pose and the reference pose. For instance, an estimated climbing pose may be compared with one or more predetermined pose reference that are considered as a high-risk climbing activity.

In addition, the accident prediction module 140 may also determine the presence of a real-world object and the interaction between the elderly user 20 and the real-world object. For instance, the accident prediction module 140 may determine the lifting of a heavy object based on the combination of the vertical displacement of an identified object and the horizontal displacement of the identified object together with the elderly user 20. The accident prediction module 140 may also determine the presence of water or other obstacles on the floor and identify a slippery floor. In the event that the accident prediction module 140 detects that the elderly user 20 is running on the slippery floor or a floor with obstacles, this would also be predicted as a potential hazard event.

The computing apparatus 100 may also provide the necessary computational capabilities to operate or to interface with a machine learning network, such as a neural network model, to provide various functions and outputs. The neural network may be implemented locally, or it may also be accessible or partially accessible via a server or cloud-based service. The machine learning network model may also be untrained, partially trained or fully trained, and/or may also be retrained, adapted, or updated over time.

In one example embodiment, the accident prediction module 140 may utilize advanced computer vision and machine learning algorithms such as pretrained object detection algorithm to process the images captured by the image capturing unit 120. For instance, the computing apparatus 100 may comprise a machine learning network model configured to determine one or more parameters associated with the potential hazardous event. In this scenario, the activity of the elderly user 20 would be continuously captured by the camera 120 and the pose of the elderly user 20 would be continuously estimated by the accident prediction module 140. By utilizing the algorithm, the image capturing unit 120 feed is analyzed in real-time to detect and track hazardous events associated with the target user 20. Meanwhile, the estimated pose of the elderly user 20 would also feedback into the machine learning network model so as to retrain the machine learning network model from time to time and further improve the accuracy of the prediction.

The computing apparatus 100 comprises one or more databases that store different data that is utilized by the processor 102. In the illustrated embodiment the apparatus 100 comprises a user database 150. The user database includes information regarding users e.g., name, date of birth, age, address etc. The database 150 can be created during a registration process in which a user may register via an app on their computing apparatus 100. The computing apparatus 100 further comprises a pose estimation database 160. The pose estimation database 160 is configured to store a pose lookup table (LUT) with various poses. These databases 150, 160 may be stored on a cloud service or at a remote server and may be accessible by the processor 102.

The computing apparatus 100 includes a software application (i.e., an app) that is stored in a memory unit e.g., ROM 104 or RAM 106 or another memory unit. The software application includes computer readable and executable instructions. The processor 102 is configured to execute the instructions to cause the processor 102 to perform one or more functions defined in the instructions. The application may control the processor 102 to estimate the pose of the elderly user 20, predict the potential hazardous event of the elderly user 20, and alert a remote user 40, or provide a chat function.

Preferably, the software application may also be installed as a mobile app on the smartphone device 170 of the caretaker 40. In addition to providing real-time footage for monitoring, the mobile app will also alert relevant users or family members through real-time messages. Accordingly, they can act promptly to ensure the safety of the elderly user 20.

Optionally, the hardware of the computing apparatus 100 may further comprise one or more sensing units to capture the audio output associated with the target user 20. The sensing unit here may be an audio capturing module i.e., an audio receiver e.g., a microphone (not shown) which captures the sound data associated with the interaction between the target user 20 and the computing apparatus 100. The computing apparatus 100 may also include a speaker unit for providing audible information to the target user 20.

In one example the computing apparatus 100 may be a user computing apparatus. The computing apparatus 100 may be a tablet, smartphone, laptop or other personal computing device. The application is installed on the computing apparatus 100 and once executed controls functions of the computing apparatus 100.

In an alternate configuration, the user database 150 and the pose estimation database 160 may be stored at a server. The application executing on the user's computing apparatus 100 may be configured to control the processor 102 to access one or more servers that store user data or pose estimation data and pull down this information and present it on the smartphone device 170 to the caretaker 40. In this alternative configuration the computing apparatus 100 may be configured to communicate with one or more servers or cloud services to access various information that is presented to the user as the application is executing on the computing apparatus 100 and as the user is interacting with the computing apparatus 100.

In this example embodiment, the computing apparatus 100 may be implemented by any computing architecture, including portable computers, tablet computers, standalone Personal Computers (PCs), smart devices, Internet of Things (IoT) devices, edge computing devices, client/server architecture, “dumb” terminal/mainframe architecture, cloud-computing based architecture, or any other appropriate architecture. The computing apparatus 100 may be appropriately programmed to implement the invention. The computing apparatus 100 may execute an application (app) to implement the various functions defined by the application.

For instance, the processor 102 of the computing apparatus 100 is configured to provide a reminder function. The processor 102 is configured to generate a notification and recommendations for further action. The reminder comprises information regarding the potential hazardous event as predicted by the system, and the estimated pose leading to the prediction is also presented on the display such that the caretaker is aware of the situation. Alternatively, the processor 102 may also be configured to automatically send a notification to the emergency center so that immediate rescue actions can be taken timely.

Moreover, the present invention may be designed to be modular, allowing it to be attached to any area of real-world environment 30 with very minor pre-setting. This modularity ensures that the accident prevention system 10 can be easily adapted and integrated into various real-world environment, providing flexibility and scalability for different applications.

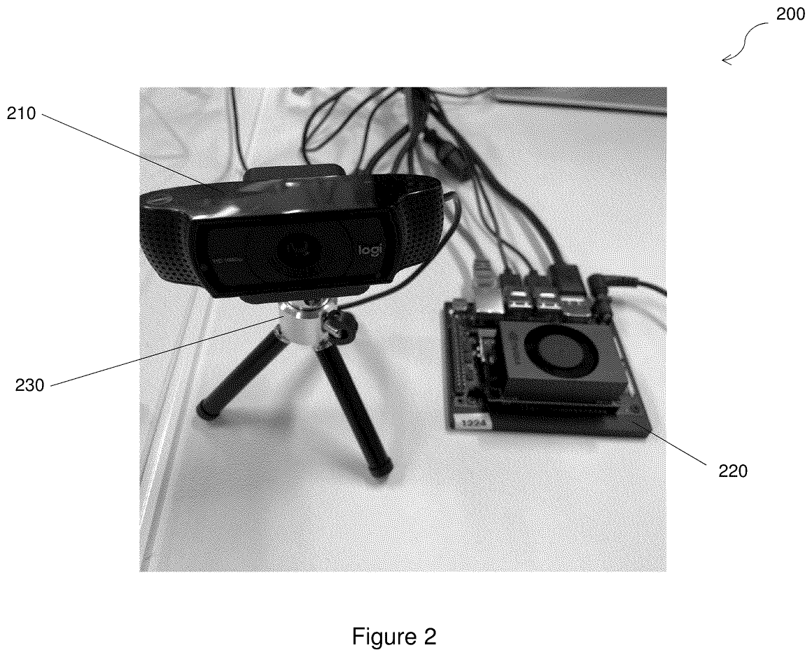

With reference now to FIG. 2, there is shown an embodiment of an accident prevention system 200 in accordance with another example embodiment of the present invention. The computing apparatus 100 and the image capturing module 120 as shown in FIG. 1 can be embodied as the accident prevention system 200 as shown here.

Preferably, the accident prevention system 200 may include an image capturing module 210 e.g., a webcam using web lens with a high resolution and frame rate e.g., 1080p and 30 fps so as to record a plurality of images in sequence within a predetermined time period. The image capturing module 210 may capture the activity of the elderly user 20 in real-time.

The accident prevention system 200 may further include a microcomputer 220 with a processing unit for executing one or more applications so as to process the image captured by the image capturing module 210 based on some calculations and analyses the pose of the elderly user 20 with reference to the pose lookup table. The image capturing module 210 and the microcomputer 220 may be in a signal communication and preferably connected via a router (not shown). For instance, the image captured by the image capturing module 210 may be feed into the microcomputer 220 for data processing. By predicting the activity of the elderly user 20, the microcomputer 220 may predict the potential hazardous event of the elderly user 20 that is likely to happen if no remedy action is taken.

Preferably, the image capturing module 210 may be detachably mounted on a tripod 230 such that the image capturing module 220 is stably secured with respect to a ground surface. Alternatively, the image capturing module 220 may be pivotably and rotatably mounted on an aim base via a pivotable joint such that the image capturing module 220 can be movably and rotatably mounted on the ground surface. For instance, the movement of the aim base may be actuated by a motor which is in signal communication with the microcontroller 220 such that the speed and direction of the aim base and the orientation of the image capturing module 210 can be adjusted to maintain the target user 20 within the field of view of the image capturing module 210.

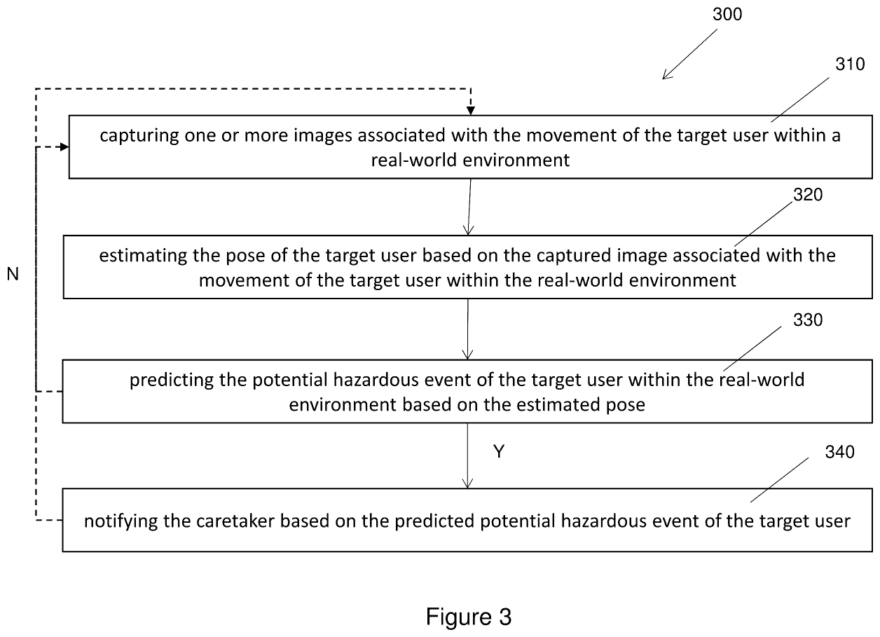

The operation mode of the accident prevention system 10 in accordance with one example embodiment of the present invention is now further described with reference to FIG. 3.

Referring to FIG. 3, the accident prevention method 300 for early detection of a potential accident of a target user 20 begins with step 310. Step 310 comprises capturing one or more images associated with the movement of the target user 20 within a real-world environment 30. Step 320 comprises estimating the pose of the target user 20 based on the captured image associated with the movement of the target user 20 within the real-world environment 30. Step 330 comprises predicting the potential hazardous event of the target user 20 within the real-world environment 30 based on the estimated pose. The estimated pose by the pose estimation module 130 will then be analyzed and compared with the various poses stored in the pose lookup table (LUT) of the pose estimation database 160.

Step 340 comprises notifying the caretaker 40 based on the predicted potential hazardous event of the target user 20. If the similarity between the estimated pose is lower than a predetermined threshold, the activity of the target user 20 would be discarded and the method 300 would repeat steps 310 to 330. If the similarity between the estimated pose is higher than the predetermined threshold, the activity of the target user 20 would qualify as a predicted hazardous event and the method 300 would subsequently proceed to step 340. Meanwhile, the method 300 would also repeat steps 310 to 330 so as to collect the statistics regarding the high-risk daily event associated with the target user 20.

Advantageously, the innovative technology of the present invention may capture character movements and displays the motion of each joint in the form of a stickman. The system also has the ability to detect household objects in real-time. The system of the present invention is also capable of accurately analyzing potential hazards in the real-world environment 30.

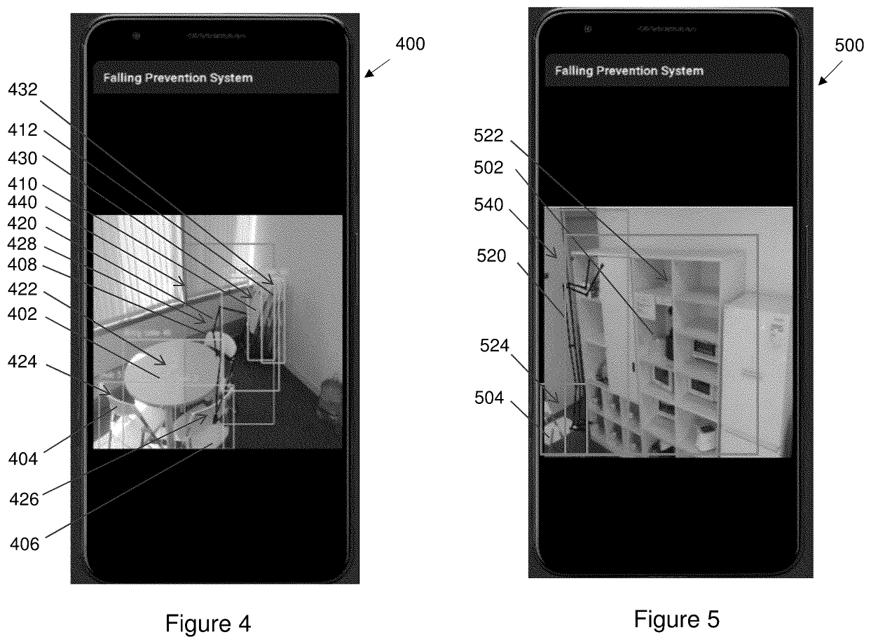

With reference to FIGS. 4 to 6, there is shown a series of splash screen 400 to 600 each displaying a processed image with information associated with the target user 20 and the objects in a real-world environment 30. In each of the pose estimation, the target user 20 and the objects in the real-world environment 30 are detectable by the accident prediction module 140 in a corresponding region of interest ROI of the captured image. Accordingly, the accident prediction module 140 may provide an object recognition function as well as a person recognition function simultaneously.

Advantageously, image of the target user 20 will turn into a stickman and thus the privacy of the target user 20 is protected. Besides, the original captured image data by the minicomputer is not accessible by other third parties. The relevant actions of the target user 20 would not be recorded prior to their consents and authorizations.

In one example embodiment as shown in FIG. 4, there is shown the splash screen 400 in which a typical indoor office environment is provided. For instance, the office setup may include a meeting table 402, three unfolded chairs 404, 406, 408, and some folded chairs 410, 412 lying on the wall for temporary storage. A target user (not shown) is sitting on one of the foldable chairs 408. However, a stickman 420 corresponding to the limbs of the target user 20 would be depicted instead of the target user 20 in the processed image.

Initially, the accident prediction module 140 may detect all the region of interest (ROI) corresponding to the objects and the target user 20. For instance, the ROI of the meeting table 402 would be detected as ROI 422, the ROI of the corresponding three unfolded chairs 404, 406, 408 would be detected as ROI 424, 426, 428, and the ROI of the corresponding folded chairs 410, 412 would be detected as ROI 430, 432. The ROI of the stickman 420 would be detected as ROI 440.

Next, the accident prediction module 140 may estimate the pose of the target user 20 based on the pose of the stickman 420 within the ROI 440. Based on the estimated distance between ROI 428 of the unfolded chair 408 and ROI 440 of the stickman 420, the accident prediction module 140 may estimate that the target user is sitting properly on the unfolded chair 408 and would not trigger an alert to the remote caretaker 40.

However, in one alternative example not shown in FIG. 4, if the target user 20 is not sitting properly on the unfolded chair 408 e.g., one is leaning back the backrest of the chair 408 excessively, the chair 408 would no longer achieve static equilibrium soon and the target user 20 may fall from the chair 408. In such scenario, the accident prediction module 140 may estimate an improper sitting behavior based on the estimated orientation of the ROI 428 of the unfolded chair 408 and ROI 440 of the stickman 420 and trigger an alert to the remote caretaker 40.

In one example embodiment as shown in FIG. 5, there is shown the splash screen 500 in which another typical indoor office environment is provided. For this particular setup, it may include a shelf 502 with a plurality of storage compartments and some storage compartments are located at an elevated position and difficult to access. To access the storage at the elevated position, it is very common that the elderly user 20 may stand on an unfolded chair 504 so as to reach the item. The stickman 520 corresponding to the limbs of the target user 20 would be depicted instead of the target user 20 in the processed image.

Initially, the accident prediction module 140 may detect all the region of interest (ROI) corresponding to the objects and the target user 20. For instance, the ROI of the shelf 502 would be detected as ROI 522, the ROI of the unfolded chair 504 would be detected as ROI 524, and the ROI of the chair 504 would be detected as ROI 524. The ROI of the stickman 520 would be detected as ROI 540.

Next, the accident prediction module 140 may estimate the pose of the target user 20 based on the pose of the stickman 520 within the ROI 540. Based on the estimated distance between ROI 522 of the shelf 502, ROI 524 of the unfolded chair 504, and ROI 540 of the stickman 520, the accident prediction module 140 may estimate that the target user 20 is standing on the unfolded chair 504 and would trigger an alert to the remote caretaker 40.

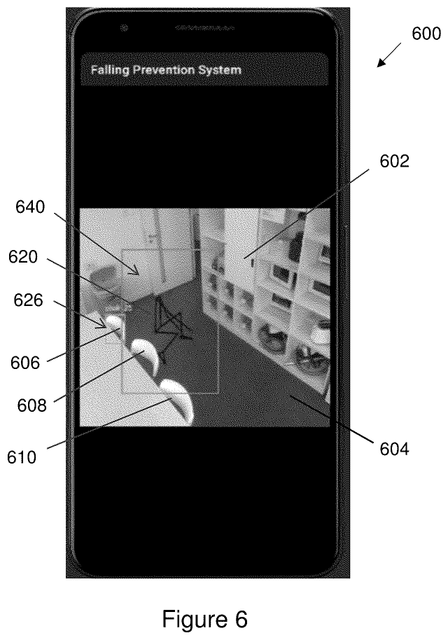

In one example embodiment as shown in FIG. 6, there is shown the splash screen 600 in which another typical indoor office environment is provided. For this particular setup, it may also include a shelf 602 with a plurality of storage compartments at an elevated position from the floor 604. It may further include a plurality of unfolded chairs 606, 608, 610. The stickman 620 corresponding to the limbs of the target user 20 would be depicted instead of the target user 20 in the processed image.

Initially, the accident prediction module 140 may detect all the region of interest (ROI) corresponding to the objects and the target user 20. For instance, the ROI of the unfolded chair 606 would be detected as ROI 626, and the ROI of the stickman 620 would be detected as ROI 640.

Next, the accident prediction module 140 may estimate the pose of the target user 20 based on the pose of the stickman 620 within the ROI 640. Based on the estimated distance between ROI 626 of the unfolded chair 606, ROI 640 of the stickman 620 and the orientation of the ROI 640 with respect to the floor 604, the accident prediction module 140 may estimate that the target user 20 is falling on the floor 604 and would trigger an alert to the remote caretaker 40.

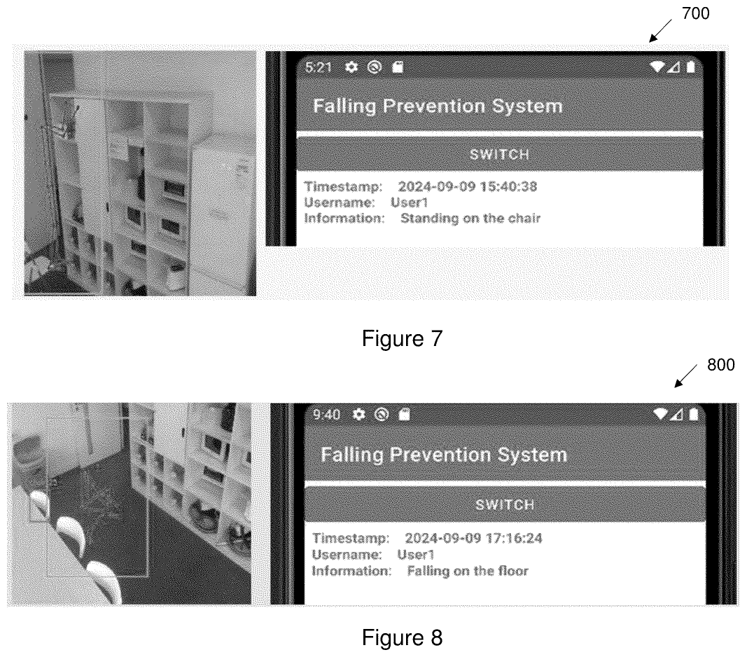

With reference finally to FIGS. 7 to 8, there is shown a series of partial splash screen 700 to 800 each displaying the information associated with predicted hazardous event accompanying the stickman depicted in the processed image projected on the display of the smartphone device 170 of the caretaker 40. Each of these splash screens 700, 800 would display the timestamp of the predicted hazardous event, the entity of the target user 20, and the description of the predicted hazardous event. The partial splash screen 700 corresponds to the splash screen as shown in FIG. 5 which indicates the standing on the chair event whilst the partial splash screen 800 corresponds to the splash screen as shown in FIG. 6 which indicates the falling on the floor event.

Advantageously, the present invention may utilize high-resolution cameras strategically placed to monitor the Activities of Daily Living (ADL) of elderly individuals within indoor environments. To protect their privacy, the video feed is processed using advanced pose estimation techniques to analyze the posture and movements of individuals and visualize the skeleton instead. This ensures that personal and sensitive information are not exposed while still allowing for effective monitoring.

Advantageously, the present invention may also be equipped with AI algorithms and edge computing technologies, utilizing NVIDIA Jetson, capable of detecting fall events in real-time. Additionally, it can identify dangerous activities that may cause falls, such as climbing a ladder or standing on a chair, enabling identification of falls and risky behaviors. This proactive detection allows for timely intervention to prevent potential accidents, and the system can also provide real-time feedback to elderly individuals by mobile application, as well as their families and care givers, encouraging safer behaviors.

Advantageously, the present invention may also continuously collect data on the daily activities of elderly individuals, such as walking, sitting, sleeping and other ADLs. These data are securely stored in a database and periodically analyzed using AI techniques to detect trends and anomalies. The analysis helps in identifying factors that contribute to risks of fall. Based on the findings, personal recommendations and interventions can be provided to reduce the likelihood of falls through the mobile application. This comprehensive analysis provides valuable insights that can be used to recommend interventions and preventive measures.

Advantageously, the present invention also has significant commercialization potential due to the growing demand for elderly care solutions and related advanced technology. The system's integration of AI and IoT provides a competitive edge with proactive fall prevention capabilities. Its modular design makes it scalable for various environments, from homes to healthcare facilities.

Advantageously, the present invention can also comply with health and safety standards and data privacy regulations, facilitating market entry. Partnerships with elderly healthcare providers can enhance adoption and market reach. Additionally, the system can improve the quality of life for elderly individuals and reduce healthcare costs by preventing falls, making it a valuable investment for their families and healthcare providers.

Although not required, the embodiments described with reference to the figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilized. This will include tablet computers, wearable devices, smart phones, Internet of Things (IoT) devices, edge computing devices, standalone computers, network computers, cloud-based computing devices and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. An accident prevention system for early detection of a potential accident of a target user, comprising:
an image capturing module arranged to capture one or more images associated with the movement of the target user within a real-world environment;
a pose estimation module arranged to estimate the pose of the target user based on the captured image associated with the movement of the target user within the real-world environment; and
an accident prediction module arranged to predict the potential hazardous event of the target user within the real-world environment based on the estimated pose.

2. An accident prevention system in accordance with claim 1, wherein the accident prediction module further comprises a machine learning network model configured to determine one or more parameters associated with the potential hazardous event.

3. An accident prevention system in accordance with claim 1, wherein the identity of the target user is filtered through the pose estimation whereby the privacy of the target user is protected.

4. An accident prevention system in accordance with claim 3, wherein the pose estimation module is configured to generate a graphical representation associated with the estimated pose of the target user from the captured image.

5. An accident prevention system in accordance with claim 4, wherein the generated graphical representation associated with the estimated pose of the target user is independent of the identity of the target user.

6. An accident prevention system in accordance with claim 5, wherein the pose estimation module is configured to generate a skeleton associated with the estimated pose of the target user.

7. An accident prevention system in accordance with claim 1, wherein the accident prediction module is configured to predict the occurrence of the potential hazardous event prior to the actual occurrence of the predicted hazardous event.

8. An accident prevention system in accordance with claim 7, wherein the accident prediction module is configured to compare the estimated pose against one or more predetermined pose references.

9. An accident prevention system in accordance with claim 7, wherein the accident prediction module is arranged to determine the elevated level of the target user relative to the ground level in the real-world environment.

10. An accident prevention system in accordance with claim 7, wherein the accident prediction module is configured to determine the presence of a real-world object within the real-world environment associated with the captured image.

11. An accident prevention system in accordance with claim 10, wherein the accident prediction module is configured to determine the interaction between the target user and the real-world object within the real-world environment.

12. An accident prevention system in accordance with claim 11, wherein the accident prediction module is configured to determine the lifting of a real-world object by the target user.

13. An accident prevention system in accordance with claim 7, wherein the accident prediction module is configured to determine the velocity of the target user.

14. An accident prevention system in accordance with claim 7, wherein the accident prediction module is configured to determine the obstacle obstructing the movement of the target user within the real-world environment.

15. An accident prevention system in accordance with claim 1, wherein the accident prediction module is configured to determine the occurrence of an actual hazardous event in real-time.

16. An accident prevention system in accordance with claim 7, wherein the accident prediction module is configured to record a high-risk activity of the target user contributing to the predicted hazardous event.

17. An accident prevention system in accordance with claim 16, wherein the accident prediction module is configured to record the statistics associated with the high-risk activity of the target user.

18. An accident prevention system in accordance with claim 1, wherein the accident prediction module is configured to alert a remote user the occurrence of a potential hazardous event.

19. An accident prevention system in accordance with claim 18, further comprising a display module configured to graphically display to the remote user in real-time a skeleton associated with the estimated pose of the target user.

20. An accident prevention system in accordance with claim 18, wherein the display module is further configured to display the information associated with the predicted hazardous event.
